(19) United States
(12) Patent Application Publication
(10) Pub. No.: US 2011/0228257 A1
(43) Pub. Date: Sep. 22, 2011

(54) HOLLOW CORE FIBER LASER INDUCED INCANDESCENCE

(75) Inventors: Paulius V. Puzinauskas, Tuscaloosa, AL (US); Cosmin E. Dumitrescu, Ottawa (CA)

(73) Assignee: THE BOARD OF TRUSTEES OF THE UNIVERSITY OF ALABAMA, Tuscaloosa, AL (US)

(21) Appl. No.: 13/049,144

(22) Filed: Mar. 16, 2011

Related U.S. Application Data
(60) Provisional application No. 61/314,859, filed on Mar. 17, 2010.

(51) Int. Cl. G01N 21/59; G01J 5/00; G01N 21/47

(52) U.S. Cl. 356/51; 356/338; 356/438

(57) ABSTRACT

The present disclosure relates to measurement techniques utilizing laser induced incandescence, and specifically to laser induced incandescence measurement techniques utilizing a hollow core fiber.

### CROSS REFERENCE TO RELATED APPLICATIONS

This application claims the benefit of priority to U.S. Provisional Application No. 61/314,859, filed Mar. 17, 2010, which application is incorporated by reference herein in its entirety.

### FIELD

The present disclosure relates to measurement techniques utilizing laser induced incandescence, and specifically to laser induced incandescence measurement techniques utilizing a hollow core fiber.

### TECHNICAL BACKGROUND

Laser-induced incandescence (LII) has been used as a diagnostic technique for the determination of soot-particle volume fraction and size. Traditional LII techniques heat up particles with short laser pulses. The temperature of the analyte particles is increased to a point to produce significant incandescence of the particle. This induced thermal radiation can then be detected to establish the presence of the particles and further analyzed to determine certain particle characteristics. The incandescence from the particles is measured using collection optics and photo detectors. Using appropriate calibration and analysis of the incandescence signal, particle characteristics such as volume fraction, particle number and particle size may be estimated. The method is essentially non-intrusive and is capable of making in-situ measurements in, for example, combustion applications.

LII has been developed primarily for monitoring particulate emissions produced by the combustion of hydrocarbon fuels. LII is suitable for soot particulate measurements since the LII signal is proportional to particulate volume faction over a wide dynamic range.

LII provides a relative measure of soot concentrations and requires a calibration for quantification of soot particulate concentrations. LII has been used to measure soot particle volume fraction in steady-state and time-varying diffusion flames, premixed flames within engines and in diesel engine exhaust streams, and gas turbine exhausts.

For determination of soot concentration, the analysis of the incandescence signal at one point in time, for example just after the laser pulse, is usually sufficient. However, since heat conduction is mainly governed by particles' specific surface areas, the cooling rate is a characteristic measure for particle size since larger particles will cool more slowly than smaller particles.

LII measurement techniques traditionally utilize open optics wherein the laser radiation is exposed to air or the ambient environment of the test system. There are several disadvantageous issues associated with open optic systems including, exposure of potentially dangerous laser beams, maintaining alignment of both delivery and signal optics, access to physically obstructed locations (laser beams and light signals only travel in straight lines in open optic systems), and the need for installing windows to provide optical access to the region under test.

Thus, there is a need to address the aforementioned problems and other shortcomings associated with traditional LII measurement systems. These needs and other needs are satisfied by the compositions and methods of the present disclosure.

### BRIEF DESCRIPTION OF THE FIGURES

The accompanying figures, which are incorporated in and constitute a part of this specification, illustrate several aspects of the invention and together with the description serve to explain the principles of the invention.

FIG. 1 is a schematic illustration of a hollow core fiber cross section, in accordance with various aspects of the present invention.

FIG. 2 is a comparison of LII intensity vs. gate delay for fiber and open optic systems, in accordance with various aspects of the present invention.

FIG. 3 is a comparison of LII intensity vs. laser fluence for fiber and open optic systems, in accordance with various aspects of the present invention.

FIGS. 4 & 5 are comparisons of LII intensity vs. radial position for various fiber and open optic systems, in accordance with various aspects of the present invention.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used in the specification and the appended claims, the singular forms “a,” “an” and “the” include plural referents unless the context clearly dictates otherwise. Thus, for example, reference to “a signal” or “the component” includes mixtures of two or more signals, components, and the like.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or cannot occur, and that the description includes instances where said event or circumstance occurs and instances where it does not.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions and it is understood that there are a variety of compositions that can perform the same function that are related to the disclosed compositions, and that these compositions will typically achieve the same result.

As briefly described above, the present disclosure provides a method for measuring the particle size and/or volume fraction of, for example, soot particles resulting from a combustion process, utilizing an optical fiber. The disclosed methods and devices involve LII apparatus and techniques. These generally techniques are disclosed in U.S. Pat. Nos. 7,167,240, 7,084,963, 6,809,820, 6,700,662, 6,181,419, 6,154,277, and 5,920,388 which are all incorporated by reference herein in their entireties for their teachings of LII apparatus, operating parameters and techniques.

In one aspect, the disclosed LII technique can comprise an optical fiber that can provide one or more of the following: increased flexibility in locating one or more specific measurement points, simplified optical arrangement, and increased safety of equipment and personnel. In another aspect, the laser signal or a portion thereof can be transmitted through a hollow core fiber.

In one aspect, the incandescence from particles can be measured using collection optics and photo detectors. In various aspects, signals, such as, for example, optical signals containing information related to the incandescence, can be transmitted via any suitable method. In one aspect, such signals are transmitted via an open optical pathway. In another aspect, such signals are transmitted in a protected environment to prevent, for example, interference and/or signal degradation from particles and/or gases in the optical path. In yet another aspect, an optical fiber can be used to transmit all or a portion of such a signal. Using appropriate calibration and analysis of the incandescence signal, information such as the soot volume fraction (svf) or the primary soot particle size may be obtained. The method is essentially non-intrusive and is capable of making in-situ measurements.

The optical fiber can comprise any optical fiber composition and/or techniques suitable for use in the various aspects disclosed herein. In one aspect, the optical fiber can be hollow core optical fiber. In another aspect, the optical fiber can be a solid optical fiber. In yet another aspect, the optical fiber can comprise a core having a different composition and/or refractive index. In still other aspects, the optical fiber can comprise a combination of multiple optical fibers of the same or varying type that can, for example, be used in different portions of a measurement device.

In one aspect, the optical fiber can comprise a multi-mode cyclic olefin polymer (COP). In yet another aspect, the optical fiber can comprise a silver coated hollow fiber.

In other aspects, the optical path of the laser energy can comprise one or more optional optical elements that can, for example, adjust and/or correct problems with the laser energy. In one aspect, the optical path can comprise an optical element that can adjust and/or improve the profile of the optical beam for a particular measurement. In another aspect, the optical path can comprise an optical element that can focus and/or collimate a portion of the optical beam and thus prevent and/or reduce divergence of the beam.

In one aspect, the optical fiber is capable of transmitting and/or delivering sufficient laser power (i.e., photon flux) to the measurement particles of interest to result in incandescence. In such an aspect, the laser power necessary to result in incandescence can vary depending on, for example, the concentration of particles and/or the optical properties of the environment in which the particles are located. One of skill in the art would, in possession of this disclosure, be able to select an appropriate optical fiber for use with a specific measurement.

In one aspect, and not wishing to be bound by theory, the intensity of an LII signal can increase with increasing laser energy; however, above the particle vaporization threshold, for example, about 0.4 J/cm² at 1064 nm), the intensity of the LII signal can be independent of increases in laser fluence. In another aspect, soot shell fragmentation and significant soot particle mass loss can be observed for laser fluencies greater than 0.6 J/cm². Hence, in one aspect, fluences close to but below the vaporization threshold can be ideal for LII analysis, as such fluences can maximize the resulting LII signal but not influence particle morphological structure.

In one aspect, conventional solid optical fibers cannot deliver nanosecond pulses at the laser fluencies suitable for use with LII. For example, at high peak power, nonlinearity in the refractive index of silica glass can result in a self-focusing effect in the core region of the fiber, resulting in irreparable damage to the fiber. In another aspect, a multi-mode cyclic olefin polymer (COP) and silver coated hollow fiber can deliver sufficient laser energy for a LII measurement.

Though the current invention refers to the methods in terms of soot, the concepts can be adapted by one of skill in the art to any particle process. For example, other flame generated particulates, such as titania or silica, can be amenable to the method of the present invention as well.

The LII system can comprise a number of components including a laser, transmitting optics, receiver optics, detectors, and calibration systems. Instrumentation and electronics are commercially available or can be constructed by one of skill in the art. One of skill in the art would be able to determine components necessary and suitable for a particular LII application. Various parameters can be set and adjusted within an LII system. One of skill in the art of LII can determine those parameters and operating conditions.

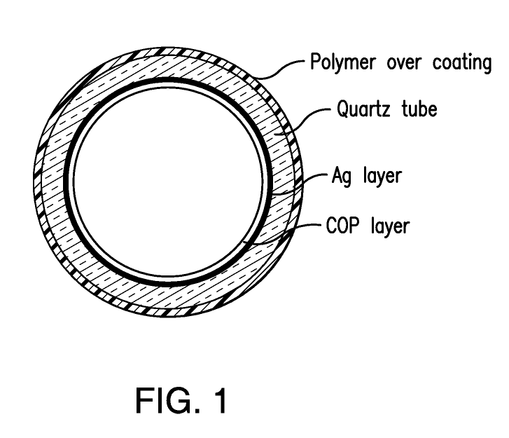

The optics can be designed so that no operator intervention is required during the normal operation of the system. In one aspect, the laser radiation or at least a portion thereof is transmitted within a hollow core fiber, such as that illustrated in FIG. 1.

In another aspect, the system can comprises an oscilloscope, an analog to digital converter, or a combination thereof. It should be noted that the particular elements, for example, detector and/or processing electronics of an LII measurement system can vary, and that one of skill in the art, in possession of this disclosure, could readily select appropriate elements for a system.

Data acquisition and management software for the LII system can be, and is preferably, used. The software can be built around the client-server paradigm for remote and local access to instrument set up, data acquisition and analysis. The software can perform correlation calculations to output a signal or display of the desired variable, e.g., particle size.

One of skill in the art of LII can select a commercially available LII system or a portion thereof, or can fabricate a desired LII system or portion thereof.

For determination of soot concentration, the analysis of the incandescence signal at one point in time (just after the laser pulse) is usually sufficient. However, since heat conduction is mainly governed by particles' specific surface areas, the cooling rate is a characteristic measure for particle size, since larger particles will cool more slowly than smaller particles. Basically, the dependence between signal decay time and particle size is proportional, i.e., smaller particles show lower decay times, but it is generally not linear. In order to increase the precision of the technique, since a single data point is collected very quickly, it is common to average the incandescence data from many laser pulses. A typical set up may use a laser with a 20 Hz repetition rate and average the data from 40 pulses, giving a single data point every 2 seconds.

In one aspect, one or more individual discrete LII measurements can be obtained for determination of, for example, volume fraction. In one aspect, a detector can obtain multiple measurements from which the incandescence decay profile can be determined. In another aspect, a detector can continuously monitor the signal intensity and provide a continuous data stream of incandescence decay data. In one aspect, the frequency at which a detector and/or data system can acquire, process, and/or store collected incandescence decay information can vary. In another aspect, the frequency at which a detector and/or data system can acquire, process, and/or store collected incandescence decay information is sufficient to determine one or more desired properties of a sample.

In one aspect, a detector, such as, a charge coupled device (CCD) can be used to measure multiple LII signals. In such an aspect, the signal is recorded with a fast oscilloscope connected to a computer, wherein data is read out and a fit provides the characteristic signal decay time. In such an aspect, t signal decay time can be correlated to primary particle size under certain environmental conditions. If capturing the exact value of particle size is desired, known ambient conditions, particularly temperature, are required. In another aspect, the detection of change requires fairly constant conditions or accordingly, information about the temperature change.

In another aspect, a photomultipler tube or detector capable of sufficiently fast measurements can be used to obtain real time or substantially real time decay profile information.

Aside from any difficulties in choosing a method that provides real-time on-line measurements, problems can exist in evaluating particle samples using a specific method. For example, in using the LII technique for in-situ measurement, appropriate in-situ techniques for pulling and preparing the sample must be provided in order to accurately and consistently perform the in-situ measurements.

In one aspect, the incandescence signal can be measured at multiple, such as, for example, two or more, wavelengths. In one aspect, the incandescence signal can be measured at two different wavelengths, for example, 400 nm (blue) and 780 nm (slightly infrared) to calculate the temperature of the particles. In another aspect, the incandescence signals from multiple laser pulses (for example, 20, 40, 100, 500, or more) can be averaged to reduce noise. In another aspect, the calculated results, for example, fineness, from each pulse can be averaged together rather than averaging the signals. In one aspect, the incandescence signal (and therefore, the temperature) rises rapidly when the laser is pulsed. After the laser pulse ends (after approximately 20 ns), the particles begin to cool due to radiation to the surrounding gas. In one aspect, the temperature is calculated from the ratio of the two incandescence signals. In such an aspect, the slope of this temperature decay can be used to compute the particle size and/or surface area.

This sizing is based on first principles in modeling, relating the rate of decay of the temperature differential between the heated particles and the surrounding medium to the size of the particles.

In one aspect, the LII measurement techniques described herein can be useful for measuring soot particles in such applications as, for example, state regulated automobile inspections. Many states currently evaluate engine exhaust systems as a portion of routine annual inspections. In one aspect, the inventive techniques can effectively determine soot levels or levels of particulate matter in an exhaust stream.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

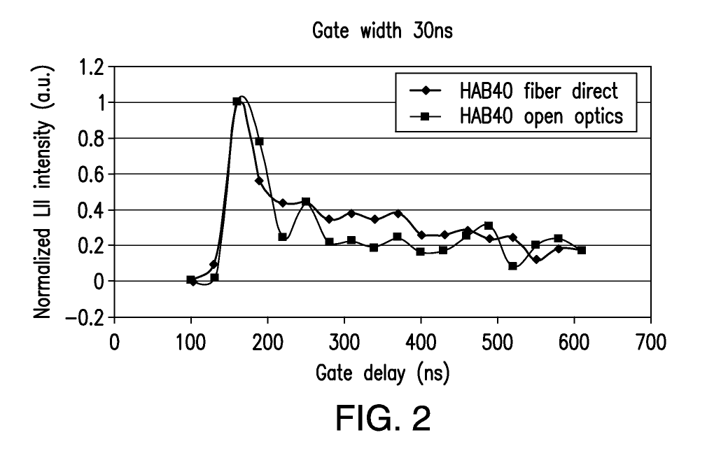

In a first example, an LII system was utilized to measure particles from a rich ethylene flame. Multiple individual measurements were obtained using a CCD camera at increasingly delayed time relative to the laser pulse. Comparisons were made between LII systems utilizing open optic systems and LII systems utilizing hollow core fiber for laser transmission. FIG. 2 illustrates the effect of signal gate delay, wherein the signals are taken from a single point in the flame. The x-axis quantifies the time between the laser pulse and signal recording. These signals are normalized by the maximum value, but the shape and delay providing the maximum signal are the same for both open optic and hollow core fiber systems.

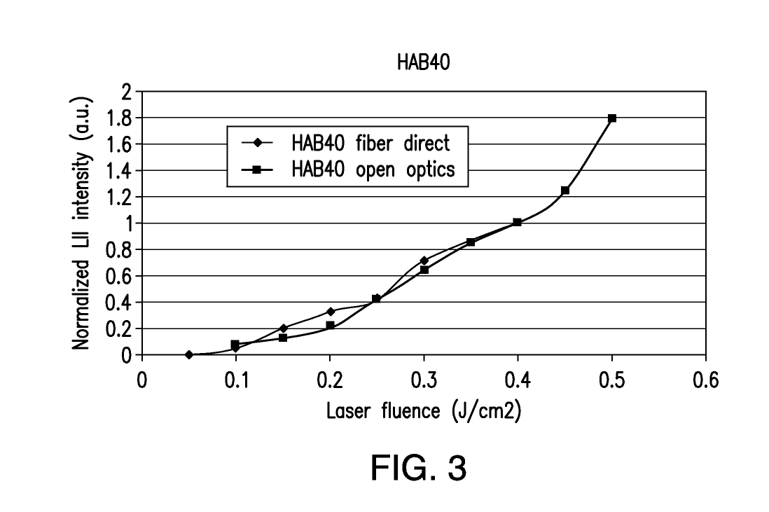

FIG. 3 illustrates how the signal is affected by laser power. As laser power is increased, the incandescence is brighter. The signals are again normalized, but the relative changes with respect to laser power are the same.

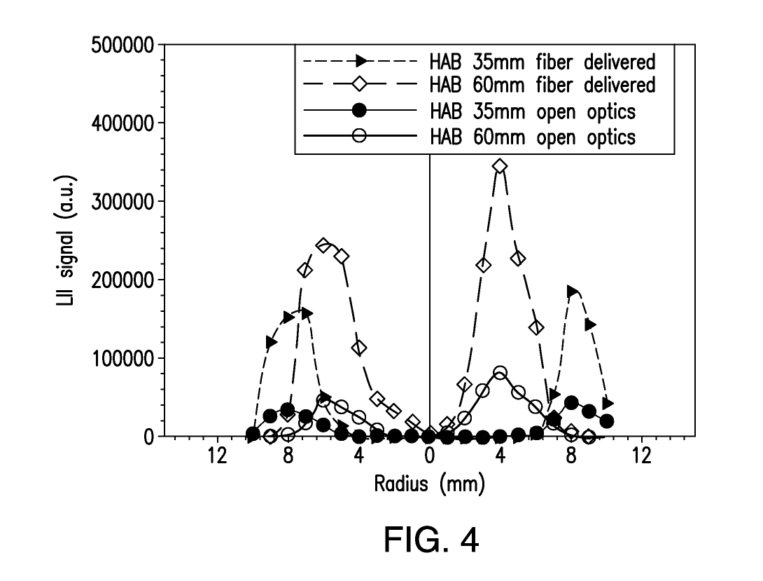

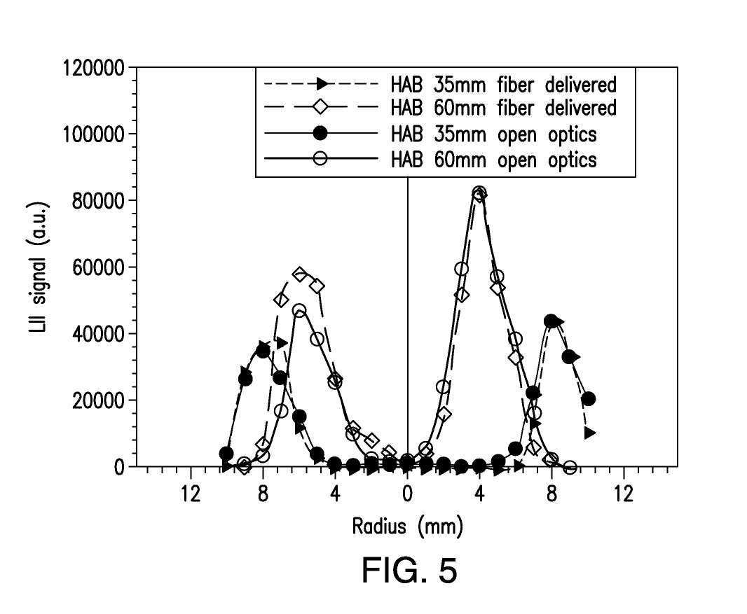

The fiber curve stops early to prevent damage to the fiber. FIGS. 4 and 5 illustrate measured and normalized incandescence signals, respectively, for fiber delivered and open optics LII systems (1064 nm, Φ=2.3, fluence 0.3 J/cm², prompt gating, gate width 30 ns).

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A device for particle characteristic determination, comprising:
a. a region for receiving the particles, wherein at least a portion of the particles are optically absorbing particles;
b. a laser light source, wherein the laser light source transmits laser light through a hollow core optical fiber to the region for receiving the particles to heat the optically absorbing particles to incandescence and causing light to be emitted from the region; and
c. at least one optical detecting unit for sensing the light emitted from the region.

2. The device of claim 1, wherein the laser light source comprises a solid state laser that optically pumps the laser light by a laser diode.

3. The device of claim 2, wherein the laser diode is a GaAlAs laser diode.

4. The device of claim 1, wherein the laser light source comprises a solid state laser having a rare earth ion doped laser crystal.

5. The device of claim 4, wherein the crystal is a Nd:YAG crystal.

6. The device of claim 1, wherein the device further comprises a power detector for detecting the power at the region.

7. The device of claim 1, wherein the device comprises a plurality of optical detecting units that are wavelength sensitive.

8. The device of claim 7, wherein each of the wavelength sensitive optical detecting units comprises a wavelength sensitive filter and a detector.

9. The device of claim 7, wherein different optical detecting units provide outputs based upon a predetermined portion of the light emitted from the region.

10. The device of claim 7, wherein a first filter passes light within a range of about 850 nm to 1150 nm, and wherein a second filter passes light within a range of about 300 nm to 780 nm.

11. The device of claim 1, wherein a first optical detecting unit detects the light emitted due to incandescence of the optically absorbing particles within a visible light wavelength range, and wherein a second optical detecting unit detects the light emitted due to incandescence of the optically absorbing particles within an infrared light wavelength range.

12. The device of claim 1, wherein the device further comprises a conduit through which the particles are passed into the region.

13. The device of claim 1, wherein the device further comprises a processing unit connected with the at least one optical detecting unit and responsive to receipt of an output therefrom.

14. The device of claim 1, wherein the laser light source also provides light that is scattered by the particles at the region; and wherein the device comprises a plurality of optical detecting units where a first optical detecting unit detects the light scattered by the particles, and where a second optical detecting unit detects the light emitted due to incandescence of the optically absorbing.

15. A method for particle characteristic determination, comprising:
a. providing particles to a region for receiving the particles, wherein at least a portion of the particles are optically absorbing particles;
b. providing a laser light source, wherein the laser light source transmits laser light through a hollow core optical fiber to the region for receiving the particles to heat the optically absorbing particles to incandescence and causing light to be emitted from the region; and
c. detecting the light emitted from the region and providing outputs indicative thereof.

16. The method of claim 15, wherein step c is performed at more than one timer interval.

17. The method of claim 15, wherein the output is temperature and/or decay rate.

18. The method of claim 15, wherein volume fraction, particle size and/or specific surface area are determined from the output.
